(19) United States
(12) Patent Application Publication
(10) Pub. No.: US 2007/0297554 A1
(43) Pub. Date: Dec. 27, 2007

(54) Method And System For Production Of Radioisotopes, And Radioisotopes Produced Thereby

(76) Inventors: Efraim Lavie, Rehovot (IL); Ido Silverman, Ness Ziona (IL); Alexander Arenshtam, Kiryat Gat (IL); Daniel Kijel, Rishon L'Zion (IL); Lea Broshi, Moshav Gealya (IL); Eliahu Sayag, Holon (IL)

Correspondence Address: NATH & ASSOCIATES, 112 South West Street, Alexandria, VA, 22314, US

(21) Appl. No.: 11/663,782

(22) PCT Filed: Sep. 20, 2005
(86) PCT No.: PCT/IL05/01004

§ 371 Date: Apr. 19, 2007

Related U.S. Application Data
(60) Provisional application No. 60/613,511, filed on Sep. 28, 2004.

(51) Int. Cl. G21G 1/10; G21C 7/32; G21G 1/00

(52) U.S. Cl. 376/190; 376/198; 376/202; 376/210

(57) ABSTRACT

A system and method for the production of radioisotopes by the transmutation of target isotopic material bombarded by a continuous wave particle beam. An ion source generates a continuous wave ion beam, irradiating an isotope target, which is cooled by transferring heat away from the target at heat fluxes of at least about 1 kW/cm².

### FIELD OF THE INVENTION

This invention relates to the production of radioisotopes, in particular by transmutation techniques. The invention is also concerned with cooling systems suitable for use in the production of such radioisotopes.

### BACKGROUND OF THE INVENTION

Transmutation of a target material to produce radioisotopes is a well-known process in which atomic nuclei in the target material interact with bombarding particles, forming compound nuclei which then decay into the desired product isotope, via the emission of one or more of elementary particles, atomic nuclei, and gamma rays. The transmutation process is typically followed by a separation process, which may be chemical or isotopic for example, to provide the pure radioisotope product. The production of radioisotopes is a critical element in a plurality of medical procedures, including diagnostic and therapeutical procedures, for example: thallium-201 (²⁰¹Tl) for cardiology applications; indium-111 (¹¹¹In), lutetium-177 (¹⁷⁷Lu) and palladium-103 (¹⁰³Pd) for oncology applications.

Indeed, there are applications, including medical applications, in which it is important to provide high yields of radioisotopes, in an economical manner, such as for example palladium 103 for prostate cancer therapy. Many such radioisotopes, using conventional transmutation techniques based on prior art particle accelerators are often not possible to produce at all, are produced with a relatively low yield, or are expensive to produce, requiring long irradiation times. For example, Table I below shows a number of exemplary isotopes, some of which cannot be produced by prior art particle beam methods, and the others of which are produced in relatively low yields per unit time on account of the relatively low power density used.

TABLE I
Particle Beam Conditions for Transmutation of
Target Material for the Creation of Isotopes

| Isotope | MeV | mA | kW | kW/cm2 |
|---|---|---|---|---|
| ¹⁷⁷Lu (d) | Reactor -produced | — | — | — |
| ¹⁰³Pd (p) | 14 | 0.4 | 5.6 | 0.56 |
| ¹⁰³Pd (d) | Not available | — | — | — |
| ¹⁸⁶Re | 28 | 0.2 | 5.6 | 0.56 |
| ⁶⁴Cu | 30 | 0.2 | 6 | 0.6 |
| ¹¹¹In | 18 | 0.18 | 3.2 | 0.32 |
| ⁶⁷Ga | 28 | 0.15 | 4.2 | 0.42 |
| ²⁰¹Tl | 30 | 0.2 | 6 | 0.6 |
| ²¹¹At | 28 | 0.1 | 2.8 | 0.28 |
| ²²⁵Ac | 28 | 0.1 | 2.8 | 0.28 |

Notes:
1. Target area assumed ˜10 cm².
2. (p)—protons
3. (d)—deuterons
4. For ¹⁷⁷Lu and ¹⁰³Pd(d) in the prior art it is not possible to produce these isotopes by cyclotrons, by deuterons irradiation.

Isotope production may be carried out generally using nuclear reactors or particle accelerators. The costs associated with the former are often very high, and for many isotopes, uneconomic. Particle accelerators comprise a relatively less expensive radioisotope production option, and include cyclotrons and linear accelerators (LINACs). Both types of particle accelerators tend to produce relatively low currents (typically in the order of microamps to less than one milliamp) of intermediate to high energy (5 to 100 MeV) charged particles, providing power densities on a target of about 0.3 kW/cm² and up to about 0.6 kW/cm².

Power density (kW/cm²) is defined by the product of the particle beam energy (MeV) and current (milliamps), per unit irradiation area (cm²) of the target, i.e., the area immediately impinged by the beam on the target. For example, when the beam impinges a target orthogonally, the area irradiated is equal to the cross-sectional area of the beam before interaction with the target. In applications where the target is at an angle to the beam, the irradiation area is correspondingly larger than the cross-sectional area of the beam. In some developmental applications, higher power densities of up to 0.8 kW/cm² have been produced for use in continuous wave accelerator systems.

In one such transmutation process known in the art, a copper base plate is electrochemically plated on one face thereof with a target material (enriched thallium-203). The plate is then placed with the plated face at a shallow angle with respect to a particle beam of relatively low power density, typically about 6 kW, and the opposed, unplated face is cooled using a suitable water cooling system. A shallow plate angle is provided to minimize the heating effect and thus the possibility of the plate melting under the temperature generated by the particle beam. After a suitable irradiation period, the copper base plate is removed, and the target material scrapped off, to be subsequently processed to obtain the pure product. Such a process is time consuming and cumbersome and produces a relatively low yield of radioisotopes. Moreover, the copper backing tends to affect the isotope production by partially transmuting to zinc, which also needs to be removed from the final product. Also, the cooling system operates at a relatively high pressure, of the order of 20 atmospheres gauge pressure, so that the copper plate needs to be strong enough to avoid rupturing, which would otherwise allow the water to flow into the vacated apparatus where the particle beam is generated.

In U.S. Pat. No. 5,405,309, a target for use in a charged particle accelerator is prepared by depositing rhodium metal onto a silver or copper substrate and the target bombarded with protons or deuterons, with the energy of the impacting particles being chosen such that a modest yield of carrier-free ¹⁰³Pd is created on the target. In WO 03/063181, radioisotopes are produced by irradiating a suitable target with an ion particle beam, and then heating the target to bring about an efflux of the desired radioisotope, which is extracted as a gas and subsequently condensed to a solid or liquid.

It is believed that the use of high power continuous wave particle beams (in the order of 100 MeV) may have disadvantages, such as the production of unwanted isotopes and radioactivation side effects usually associated with them. (Further, in “Study on alternative production of ¹⁰³Pd and characterization of contaminants in the deuteron irradiation of ¹⁰³Rh up to 21 MeV” (A. Hermanne et al, Nuclear Instruments and Methods in Physics Research B 187 (2002) 3-14), a continuous wave particle beam having incident energies of about 15 MeV and about 20 MeV was used for the production of ¹⁰³Pd. This publication concluded that increasing the incident deuteron energy above 20 MeV was not a profitable exercise for the production of ¹⁰³Pd.) In any case, while such problems are much less significant in lower power particle beams, the limited current available in conventional accelerators seriously limits the ability of such accelerators to produce isotopes economically.

U.S. Pat. No. 5,848,110 attempts to teach away from high beam kinetic energies, or from using continuous wave ion beams. An apparatus is disclosed for transmuting target isotopes using a high repetition rate high energy pulsed power source directed to target isotopes, and means for cooling the target, where the average power of the beam pulses is greater than 1 kW, and the average beam current is greater than 10 milliamps. The pulsed configuration of the device when used with a foil-shaped target of appropriate thermal conductivity enables the heat from one beam pulse to have time to penetrate into a heat sink on the other side of the target before the next pulse arrives. Otherwise, the heat buildup is such that the target would break up in some manner. However, the beam energy is limited to 20 MeV, which does not allow the production of several important isotopes, such as for example ²⁰¹Tl. Further, it is well known that pulsed power surges generated by such systems cause thermal stresses in targets which lead to irreversible damage of the same.

Any attempt at using increased current or power of a continuous wave particle beam is not a straightforward undertaking, and would necessitate additional cooling preparations, which is also not a straightforward proposition. As the particle beam impinges onto a target, this begins to experience a temperature rise arising from the need to dissipate the thermal power generated by the beam, and a heat sink behind the target may be advantageously used for absorbing a high proportion of this power. As the beam continues to be projected onto the target, unless the heat removal capacity of the heat sink is matched to the heat input of the particle beam, the temperature of the target will continue to rise as ions from the beam interact with the target until the target breaks down. In particular, where the target has a relatively low melting point, proper cooling is essential. Further, the cooling capacity must also be such as to maintain the target at a temperature below that at which it begins to lose mechanical integrity, otherwise the target can break down and the cooling material (especially if a fluidic material is used) can contaminate the particle beam accelerator itself.

For general background purposes, in “Liquid Gallium Cooling of a High Power Beryllium Target for use in Accelerator Boron Neutron Capture Therapy (ABNCT)”, by B. W. Blackburn, J. C. Yanch, Proceedings of the 8th Workshop on Targetary and Target Chemistry. St. Louis, Mo., a heat removal system is discussed for a neutron producing beryllium target by means of high velocity cooling fluid impingement onto the target using a submerged jet impingement configuration, with either water of gallium as the cooling fluid. This paper was followed up by “High-Power Target Development for Accelerator Based Neutron Capture Therapy, B. W. Blackburn (2002), PhD Thesis, MIT, Boston, Mass., in which a cooling system for a neutron producing beryllium target was investigated, using water and gallium separately. An accelerator rated at 2 mA, and up to 4.1 MeV (>8 kW) was used, but related specifically to low Z materials for the production of neutron flux. The cooling system comprised a submerged nozzle in which the nozzle to target distance was fixed at 1.75 nozzle diameters. The reference further infers that at nozzle to target distances less than unity there would be a significant increase in flow resistance resulting in the need for extremely large system pressures.

### SUMMARY OF THE INVENTION

The present invention relates to a system and method for the production of radioisotopes by the transmutation of target isotopic material bombarded by a continuous wave particle beam. Typically, a target material is irradiated with a high power continuous wave particle beam.

The system comprises:
a source for generating a continuous wave ion beam;
a target for said beam comprising a target isotope and positioned such that said beam interacts with said target isotope;
cooling means for cooling the target.

Correspondingly, the method comprises:
generating a continuous wave ion beam;
irradiating a target comprising said target isotope with said beam, wherein said target is positioned such that said generated beam interacts with said target isotope;
transferring heat away from said target.

The cooling means for cooling the target is typically configured for enabling transference of heat away from said target at heat fluxes of at least about 1 kW/cm², or alternatively higher than about 1 kW/cm² and up to and including any one of at least 2.8, or 3, or 3.4, or 3.6, or 5.6, or 6, or greater than 6 kW/cm².

The ion source is in the form of a suitable linear accelerator that provides a continuous wave particle beam, which typically comprises protons, alpha particle or deuterons. Further, the particle beam may be used to generate neutrons for bombarding a target therewith, by first bombarding a neutron generating target with the beam, and directing the generated neutrons to the desired target. The particle beam according to the invention is configured to generate beam energies typically in the range about 10 MeV to about 40 MeV, and more typically between about 15 MeV to about 30 MeV, though in some embodiments the beam energy may be less than 10 MeV or greater than 40 MeV. The beam current is typically between about 2 mA to about 4 mA, though in some embodiments the beam current may be less than 2 mA, typically in the range 0.1 to 2 mA, or greater than 4 mA. For example, the working range of the LINAC in one embodiment of the present invention may be from: 10 MeV and 0.1 mA (power=1 kW); to 40 MeV and 2 mA (power=80 kW).

Beam powers range typically between about 20 kW to about 80 kW, though in some embodiments the beam energy may be less than 20 kW or greater than 80 kW, including up to 160 kW or greater. Beam power densities may be in the range of about 2 kW/cm² to about 8 kW/cm², though in some embodiments the beam energy may be less than about 2 kW/cm² or even less than about 1 kw/cm², or greater than about 8 kW/cm², including up to about 16 kW/cm² or greater, based on a target area of about 10 cm².

Comparison of Table II (below) with Table I (above) demonstrates the significant advantages in the present invention in producing isotopes, not presently available with known LINACs, or at higher yields than hitherto.

TABLE II
Optimal Current and Associated Minimum Energy Conditions
for Producing Radioisotopes According to the Invention

| Isotope | Energy (MeV) | Current (mA) | kW |
|---|---|---|---|
| ¹⁰³Pd | 17 | 2 | 34 |
| ¹⁷⁷Lu | 30 | 2 | 60 |
| ¹⁸⁶Re | 28 | 2 | 56 |
| ⁶⁴Cu | 35 | 1 | 35 |
| ¹¹¹In | 18 | 1 | 18 |
| ⁶⁷Ga | 28 | 1 | 28 |
| ²⁰¹Tl | 30 | 1 | 30 |
| ²¹¹At | 28 | 0.5 | 14 |
| ²²⁵Ac | 35 | 1 | 35 |
| ¹²⁵I | 40 | 0.5 | 20 |

Herein, “target material” refers to the material that it is desired to irradiate with a particle beam to produce at least one radioisotope of interest.

The target is held in a target station and positioned such that the beam can directly interact with it (in the case of protons, alpha particle or deuterons), or indirectly (in the case of neutrons) on one face of the target. The target is typically in the form of a foil of target material held in a mechanically stable frame that is configured to be mounted onto the target station. Targets are typically disc-like and circular, but may be any other shape such as polygonal, oval etc., and, in some embodiments, are aligned orthogonally to the incident particle beam. In other embodiments, the targets are aligned at an angle to the beam, thereby reducing the effective beam density impinging on the target. In some embodiments the target material may be plated or otherwise deposited onto a substrate made from a different material. In yet other embodiments, heat-sink materials, such as indium, or graphite, are provided as an intermediate layer between the target material layer and the substrate layer. The intermediate layer may be configured to melt when the system is in operation, and the melted layer provides improved thermal contact between the target layer and the substrate layer.

Target materials for the target to be radiated may include, but is not restricted to, any of the following materials: copper, molybdenum, gold, silver, niobium, tungsten, rhodium, tungsten, ytterbium, radium, zinc, bismuth, tantalum, silver, rhodium, cadmium, zinc, nickel, radium, thallium, and iodine.

In some embodiments, the target station may be configured for easy removal of the target, which may be fitted to a cartridge-like frame, and in a manner that prevents contamination or communication between the vacuum of the linear accelerator, and the cooling fluid of the cooling means.

The cooling means is capable of providing sufficient cooling to the target, the reverse face thereof with respect to the face that is being irradiated, when this is subjected to such power densities, such that the target retains mechanical integrity. Thus, the cooling system is configured for enabling transference of heat away from said target at heat fluxes of at least 1 kW/cm², and typically from up to about 2 kW/cm² to about 8 kW/cm², though in some embodiments the beam energy may be greater than about 8 kW/cm², including up to about 16 kW/cm² or greater. The cooling system is based on submerged jet impingement of a cooling fluid to a reverse side of the target (i.e., the face on the other side of the target with respect to the face that is being bombarded by the particle beam), and preferably provides a suitable cooling fluid that can perform such cooling with minimal jet impingement velocities and fluid pressures.

The cooling fluid is preferably a so called liquid metal or alloy, which has a melting point lower than the working temperature of the foil. Such liquid metals or alloys include, but are not restricted to, at least one of: Gallium, Gallium-Indium, Tin-Indium-Gallium, Mercury, Sodium-Potassium. Typically, eutectic mixtures may be used, though alternatively any ratio of metals may be used, typically according to the desired liquefaction or melting temperature. Alternatively, the working fluid may be water, or a suitable gas, such as helium for example. Preferably, the cooling system pressure and jet impingement velocity are kept as low as possible.

Typically, cooling system pressure is in the range 1 to 20 bar for liquid metals, and between 1 to 100 bar for water, as the cooling fluid.

A jet of cooling fluid is directed at the reverse face of the target via one or more nozzles. The nozzles are typically convergent-divergent nozzles, but may comprise any suitable configuration. The nozzles are aligned with their central axes substantially parallel to the beam axis; where only one nozzle is used, its axis may also be coaxial with the beam axis. The exit profile of the nozzle is typically substantially in a plane parallel to the plane of the target, in embodiments where the target is orthogonal to the particle beam, or in embodiments where the target is mounted onto a chamfered frame.

In some embodiments, the ratio of (nozzle-to-target distance):(nozzle diameter (or other dimensional parameter of the nozzle)), z/D, is less than unity, typically 0.8, but in other embodiments this parameter may be less than 0.8, or between 0.8 and 1, or higher than unity, including 6 or more.

The system of the present invention further provides a purification subsystem for purifying the said radioisotope from residual materials remaining after said interaction between the particle beam and the target material. Correspondingly, the method of the present invention further comprises the step of purifying the said radioisotope from residual materials remaining after said irradiation.

Thus, according to the invention, a purification process is applied to the target after irradiation thereof, to obtain the pure isotopic material. Purification may be chemical or isotopic. The irradiated target is transferred to hot cells, having been encapsulated in a suitable radiation impervious shield, such as a lead shell for example. Transference may be manual, or automated, for-example via a pneumatic arrangement that forces the target through a tube connecting the target station to the hot cell. Chemical or isotopic processing is carried out in the hot cell, and the purified isotope is the suitably packaged for storage or for transportation to a user.

The present invention may be utilized for the transmutation of target materials for the production of a wide range of radioisotopes including but not limited to:
(a) Lutetium 177 (¹⁷⁷Lu) obtained from target material ytterbium 176 (¹⁷⁶Yb).
(b) Palladium 103 (¹⁰³Pd) obtained from target material natural rhodium (¹⁰³Rh).
(c) Lutetium 177 (¹⁷⁷Lu) obtained from target material Tantalum 181 (¹⁸¹Ta).
(d) Palladium 103 (¹⁰³Pd) obtained from target material natural silver.
(e) Rhenium 186 (¹⁸⁶Re) obtained from target material tungsten 186 (¹⁸⁶W).
(f) Copper 64 (⁶⁴Cu) obtained from target material natural zinc.
(g) Copper 64 (⁶⁴Cu) obtained from target material nickel 64 (⁶⁴Ni).
(h) Indium 111 (¹¹¹In) obtained from target material cadmium 112 (¹¹²Cd).
(i) Gallium 67 (⁶⁷Ga) obtained from target material zinc 66 (⁶⁶Zn).
(j) Gallium 67 (⁶⁷Ga) obtained from target material zinc 67 (⁶⁷Zn).
(k) Thallium 201 (²⁰¹Tl) obtained from target material thallium 203 (²⁰³Tl).
(l) Astatine 211 (²¹¹At) obtained from target material natural bismuth.
(m) Iodine-125 (¹²⁵I) obtained from target material natural iodine.
(n) Actinium 225 (²²⁵Ac) obtained from target material radium 226 (²²⁶Ra).

### BRIEF DESCRIPTION OF THE DRAWINGS

In order to understand the invention and to see how it may be carried out in practice, a number of embodiments will now be described, by way of non-limiting example only, with reference to the accompanying drawings, in which:

FIG. 1 schematically illustrates elements of the system of the invention.

FIG. 2 is a transverse cross-sectional view of one embodiment of the isotope target according to one embodiment the invention.

FIG. 3 schematically illustrates elements of the experimental set up used for investigating rupture parameters for foils.

FIGS. 4(a), 4(b), 4(c) are respectively a transverse cross-sectional view, a top view and an end view of one embodiment of the target according to another embodiment of the invention.

FIG. 5 illustrates in fragmented cross-sectional view part of the cooling system according to an embodiment of the invention associated with the target of FIG. 2.

FIGS. 6(a), 6(b), 6(c) are respectively a fragmented transverse cross-sectional view, a partial top view and a partial end view of the cooling system according to another embodiment of the invention associated with the target of FIGS. 4(a) to 4(c).

FIGS. 7 and 7(a) are respectively a fragmented transverse cross-sectional view, and a partial top view of the cooling system according to the embodiment of FIGS. 6(a) to 6(c), associated a target according to another embodiment.

FIG. 8 illustrates in fragmented transverse cross-sectional view the irradiation subsystem according to another embodiment of the invention.

FIG. 9 presents some results of a high power experiment with 10 mm diameter target heating area.

FIG. 10 illustrates target temperature results as a function of radial position at Z=1 mm for a heating power of 1.9 kW/cm² and cooling jet velocity of 3.25 m/s.

### DETAILED DESCRIPTION OF THE INVENTION

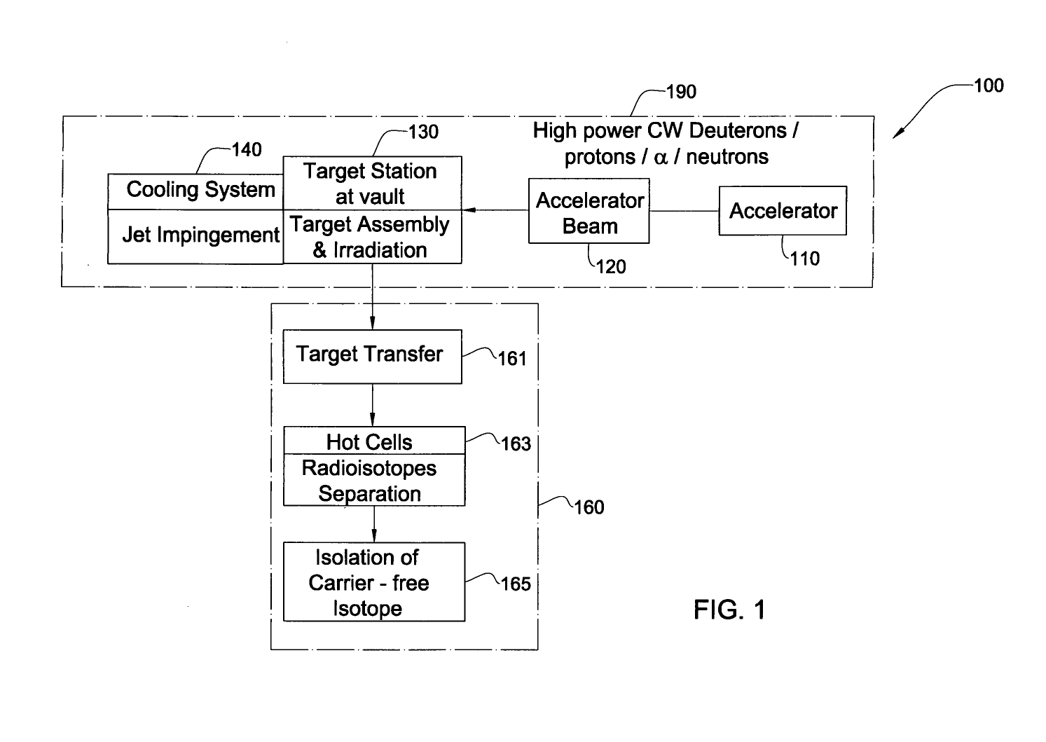

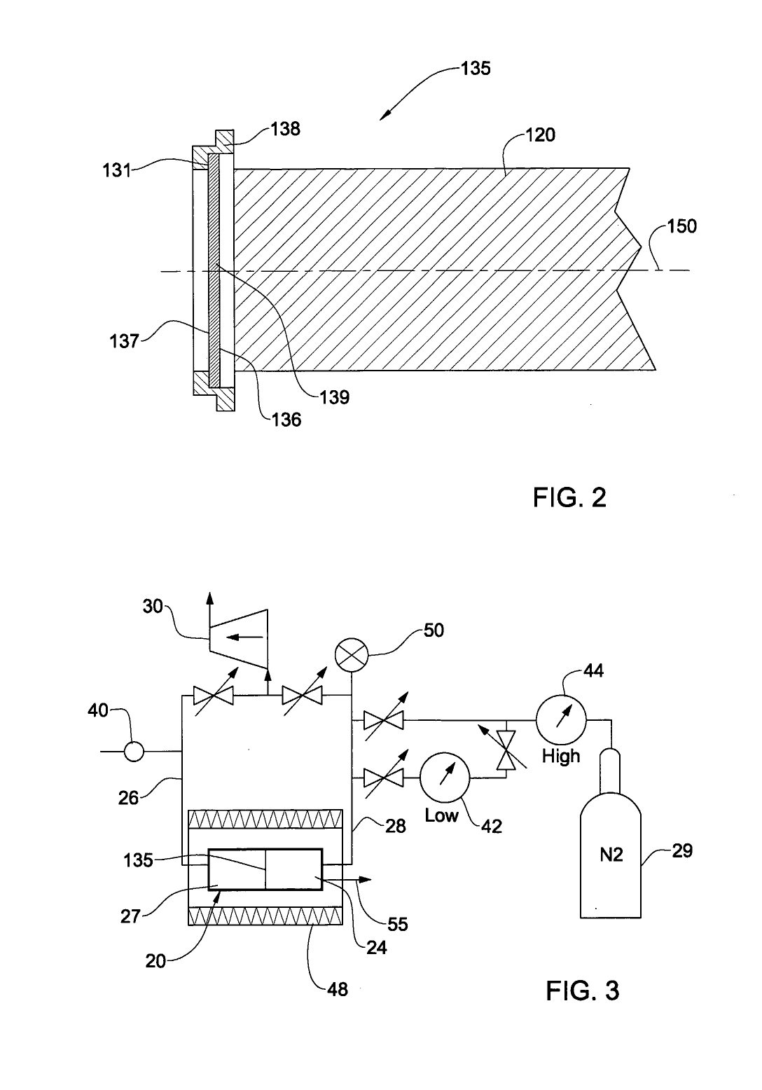

With reference to FIGS. 1 and 2, a first embodiment of the system for producing isotopes, generally designated 100, comprises an irradiation subsystem 190, and a purification subsystem 160. The irradiation subsystem 190 comprises a source 110 for generating a high energy continuous wave particle beam 120, a target station 130 comprising a target in the form of a metallic foil 135 to be irradiated by the source 110, and a cooling system 140 for cooling the foil 135. The purification subsystem 160 is adapted for separating the desired radioisotope from other materials remaining in the foil 135.

In the first embodiment of the irradiation subsystem 190, the source 110 typically comprises a linear accelerator (LINAC) adapted for generating a particle beam 120 comprising protons, alpha particles or deuterons. The source 110 can also generate neutrons, though typically indirectly by bombarding a suitable auxiliary target with protons, alpha particles or deuterons, e.g. beryllium with deuterons, bismuth with protons, and so on. The source 110 is capable of providing a beam current rated at about 2 mA, or up to about 4 mA or greater, with a beam energy typically within the range including from about 10 MeV to about 30 MeV, and preferably from about 15 MeV to about 40 MeV, though greater energies than 40 MeV, or less than 10 MeV, may also be generated. Accordingly, high beam powers ranging from about 20 kW to about 80 kW, or up to about 160 kW or greater may be obtained, which for average target areas of about 10 cm² provides a power density of ranging from about 2 kW/cm² to about 8 kW/cm², or up to about 16 kW/cm² or greater.

Currently, there are a variety of LINACs operating around the world, each capable of generating continuous wave particle beams, but at beam current and energy setups which are different from those of the present invention. Nevertheless, technologies for constructing superconducting RF LINACs as well as other LINACs are well understood in the art, and may be adapted for the construction of a linear accelerator for producing continuous wave particle beams of energies and current setups as required in the present invention. Accordingly, the constructional features of source 110 of the present invention are thus well within the purview and ken of a man of art, and thus does not require further elaboration herein.

The source 110 is aligned with a target station 130 comprising a target 135. The target 135 is made from or at least comprise target material that is to be irradiated by the particle beam to produce the radioisotopes of interest. Referring to FIG. 2, a typical solid target 135 comprises a foil 139 made from the target material, held within a circumscribing frame 138, which is made from a mechanically strong material such as for example stainless steel. The longitudinal axis 150 of the beam 120 thus intersects the center of the plane of the target 135 when this is mounted at the target station 130. In one form of construction, the frame 138 comprises a stepped shoulder 131 in its inner periphery, onto which a foil 139 is seated and welded. In another construction (not illustrated) the frame comprises two parts that sandwich the foil 139 therebetween ensuring full sealing between the foil and the frame parts. The frame parts may be welded together, bolted together, or held together in any other suitable manner. The frame 138 is suitably shaped to be received at the target station 130 and held there throughout the irradiation process. In the embodiment illustrated in FIG. 2, the plane of the foil 139 is substantially orthogonal to the axis 150 of beam 120.

In other embodiments particularly adapted for irradiating a target material which may be non-solid, for example gaseous as is typically the case with Iodine, the target material may be encapsulated in a capsule made from a material that does not transmute, or undergoes minimal transmutation when subjected to an irradiating beam. The capsule is in a form suitable and compatible with the remainder of the system of the invention. Thus, typically, the capsule may be made from aluminim and comprise two parallel spaced faces, typically circular, and connected by a peripheral cylindrical wall, defining a space in which the target may be accommodated. The irradiating beam is transmitted to one face of the capsule, while the other face is exposed to the cooling system.

The target 135 may be of any suitable shape, preferably having a convex periphery which may be round, oval or elliptical, polygonal, and so on.

One target face 136 of the target 135 to be irradiated is thus in communication with the source 110, while the reverse cooling face 137 of the target is in fluid communication with the cooling system 140, which is under a system fluid pressure at least when in operation, as will be described in greater detail herein. Accordingly, a differential pressure exists across the thickness of the foil at least during operation of the cooling system.

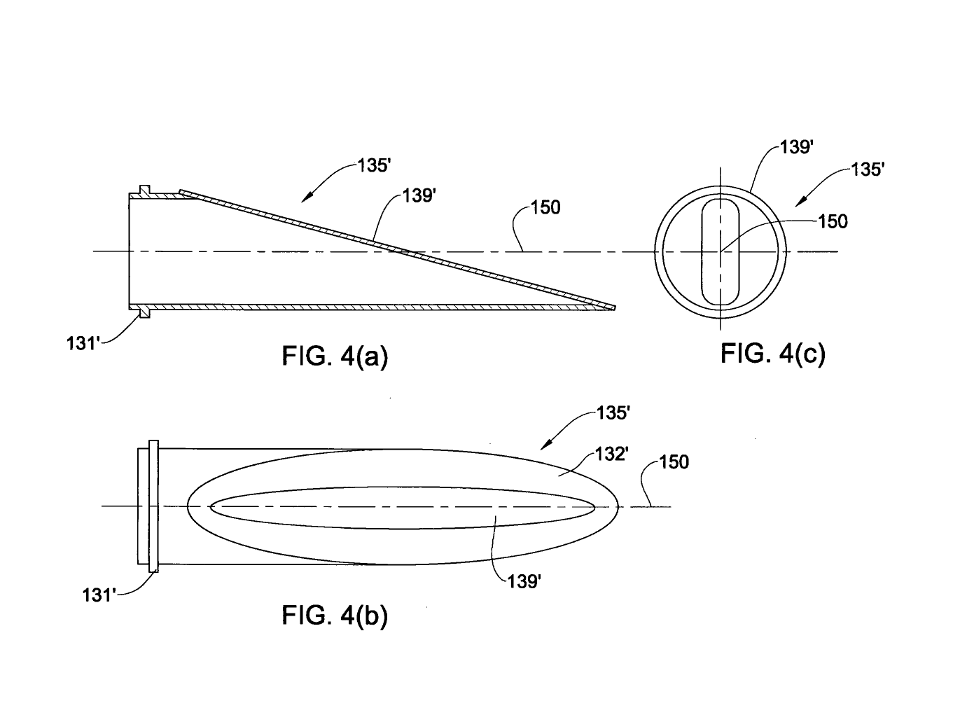

Referring to FIGS. 4(a) to 4(c), another embodiment of a target, herein designated 135′, is illustrated, comprising a substantially oval or elliptical foil 139′ carried on a substantially tubular frame 138′ having an annular downstream end 131′ (with respect to the particle beam direction) and a beveled upstream end 132′ onto which the foil, typically elliptical, is mounted so that the plane of the foil is not orthogonal but rather at an angle to the axis 150. The foil may be mounted using any suitable means, such as welding or by using a clamping arrangement, for example.

In general, the foils 139 or 139′ require to have at least the following characteristics:
High strength at elevated temperatures to maintain mechanical integrity under the differential pressure between the substantially evacuated beam line, and fluid pressure from cooling system.
High thermal conductivity to remove the heat deposited by the particle beam.
Resistance to radiation damage, i.e., mechanical damage such as cracking for example, that may be caused by radiation.

Studies have been conducted on various candidate materials based on the thermal properties of these materials, including experimental studies of various materials for thin metallic windows. Different materials have different capabilities, which would apply to different targets designs.

The present Applicant carried out an experiment to provide data on the mechanical strength of Rh foils at room temperature and at elevated temperature, and to test the accuracy of analytical procedures for determining foil failure conditions. Foil failure is defined as the differential pressure across the two faces of the foil, at a given foil temperature (or at least at the mean temperature or other datum temperature of the foil) at which fluid communication is established between the two faces of the foil as a result of rupture or disintegration of the foil.

Referring to FIG. 3, an arrangement is illustrated therein that was used for determining rupture limits, i.e., foil failure, as a function of foil temperature and differential pressure. Each foil 135 tested was held between two stainless steel frames. For some tested configurations, the frames, were are circular with inner diameter of 20 mm, defining the exposed foil area, and for other tested configurations the frames had oval or elliptical orifices, having major and minor axes of 110 mm and 22 mm, respectively. The corners of the inner side of the frames were rounded with a radius of about 0.5 mm to reduce stress in the edge of the foil as the pressure of the gas pushes it. The frames were configured as parts of a vacuum tight test vessel 20, such that the foils that were held by the frames divided the vessel into two separate vacuum tight sections, 22, 24.

Each of the sections 22, 24 was connected to a vacuum pump 30 via lines 26, 28, respectively, and valves 32, 34 on the lines enabled the pressure to be regulated in each section 22, 24. On line 26 between the section 22 and the pump 30 a relief valve 40 was set for a pressure of 0 bar gauge, i.e., to open when the pressure increased from 0 bar gauge. The second line 28 was connected to a high-pressure dry nitrogen storage tank 29 via pressure-regulating valves 42, 44 to enable to control the gas pressure during the experiment. A pressure sensor 50 provided continuous monitoring of pressure in section 24 throughout the experiment. The test vessel 20 was placed in a furnace 48 that controlled the temperature of the foil during each part of the experiment, and the corresponding temperatures were monitored with temperature sensor 55. Vacuum was maintained in one part of the system, and nitrogen gas (or indeed any inert gas) in the other part of the system during experiments to prevent oxidation of the foil at high temperature.

It should be noted that the actual operating conditions at the foil (when irradiated by a particle beam) imply a temperature distribution that is determined by the beam current, beam profile, and foil cooling system. Typically, the temperature distribution across the exposed face of the foil is expected to be Gaussian with the highest temperature at the center of the foil. However, the experimental setup was such as to provide steady state temperature conditions, wherein each steady state temperature was substantially uniform over the foil. Since foil strength generally decreases as its temperature increases, the temperature conditions investigated provide a somewhat conservative limit on the differential pressure that the foils can actually stand during real operating conditions.

For each test run in the experiment a new foil was clamped tightly between the two frames so that there was no gas leakage between the frames and the foil. The test cell 20 was then evacuated by the vacuum pump 30 and the valves were closed to separate the two sections 22, 24. Section 24 was then filled with dry nitrogen from the storage tank, and the gas pressure was set to about 1 bar gauge with the pressure-regulating valves 42, 44, and the test vessel 20 was heated to the desired temperature. Test runs were completed for temperature conditions of up to 900° C. Due to the high thermal mass of the furnace and the test section, it took about two hours each time to increase the temperature to the highest value. For each test run, after operating conditions, i.e., pressure and temperature, reached the desired steady state values the system was held at these conditions for a given time, up to 100 hours, before the pressure was gradually increased until the foil failed. Foil failure was detected by observing gas release from the relief valve 40.

For the experiment, rhodium foils were manufactured under special production conditions. In order to obtain the highest mechanical strength for the foils, in the final manufacturing step, the foil thickness was rolled to a final thickness that was not less than 55% of the original thickness. For example, a 250 μm thick foil is rolled in the final production step from 450 μm thickness. Furthermore, during the foil production, the foils were cut in a direction parallel to the rolling direction. These two operations lead to unexpectedly excellent resistance of the Rh foils thus produced to external mechanical pressure.

The results of the pressure required to breach each rhodium foil as a function of the temperature are described in Table III.

TABLE III
FOIL DURABILITY RESULTS OBTAINED FROM
TESTS USING THE SET UP OF FIG. 3

| Foil Thickness | Foil | Foil Dimensions | Temp | Foil breaching |
|---|---|---|---|---|
| (μ) | Shape | (mm) | (° C.) | pressure (atm.) |
| 25 | Circle | 20(diameter) | 24 | 7.74 |
| | Circle | 20 | 450 | 3.46 |
| 75 | Circle | 20 | 450 | 13.48 |
| 75 | Oval | 100 × 12 | 450 | 15.65 |
| 85 | Circle | 20 | 450 | 21.5 |
| | Oval | 100 × 12 | 447 | 14.22 |
| 100 | Circle | 20 | 24 | 28.90 |
| | Circle | 20 | 450 | 26.0 |
| | Circle | 20 | 666 | 24.0 |
| | Oval | 100 × 12 | 450 | 13.08 |
| 250 | Circle | 20 | 666 | >31.8 |
| 250 | Oval | 100 × 12 | 450 | >29 |
| 250 | Oval | 100 × 12 | 650 | >29 |

The following conclusions were derived from the results in Table III:

a) The maximal foil durability to the applied pressure (of the tested conditions) is at foil thickness of 250 μm.

b) There is a significant decrease in the foil pressure durability depending on the foil shape and dimensions. For example, oval-shaped-foil (110×22 mm), 100 μm thick is breached by only approx. 50% of the pressure required to breach a circle foil, diameter 20 mm having the same thickness. Applicants believe that up to 100 μm the breaching pressure is a function of the geometrical shape. However, as shown in Table III, when the foil thickness is increased, the breaching pressure is not dependent on the shape of the foil. When the temperature is elevated during the pressure application, there is a decrease in the ability of the foil to sustain the applied pressure.

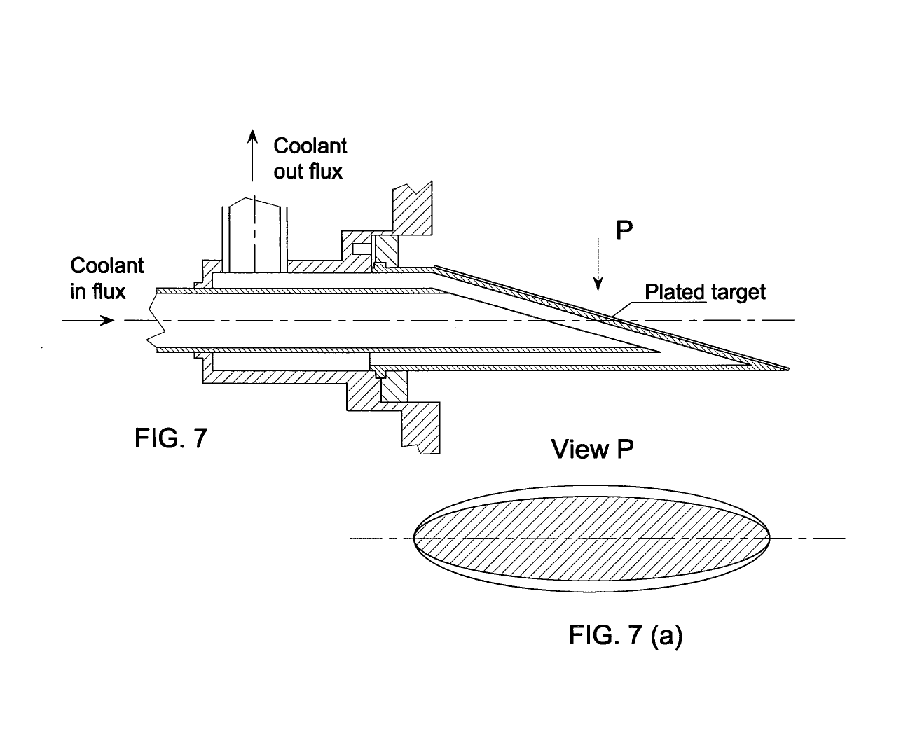

In other embodiments, for example as illustrated in FIG. 7, the target material may be coated, plated or otherwise deposited onto a substrate made from a mechanically strong material such as copper or stainless steel, for example, and the substrate can therefore be integral with the frame.

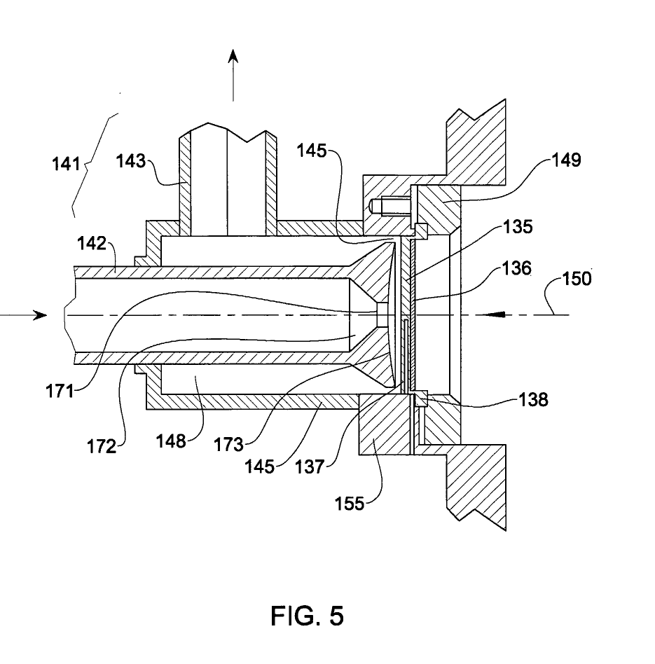

Referring to FIG. 5, the cooling system 140 comprises a fluid cooling circuit 141 directed at cooling the reverse side 137 of the target 135 (similar considerations apply to other embodiments of the target, such as for example target 139′, mutatis mutandis). The fluid circuit 141 comprises a fluid delivery line 142 adapted for delivering cooled fluid to the target 135, and a return line 143 for returning heated fluid to a heat exchanger and cooling apparatus, such as a fan and radiator for example (not shown) by means of a pump arrangement (not shown).

For example, the pump arrangement may comprise an electromagnetic pump arrangement. One such pump arrangement, of the annular induction type, and used successfully with a liquid metal by some of the inventors of the present application, is described as follows for exemplary non-limiting purposes.

Such a pump may be based on a standard 2 kW electric engine, in which the rotor is removed and replaced with a pump body, now enclosed by the original stator. The pump body comprises an inner cylindrical shell and a concentric outer cylindrical shell, and an auger arrangement in the form of helical fin or blade is accommodated in the radial gap between the inner and outer shells and joined thereto. In this particular example, the blade may be wound 5 revolutions around the inner shell; the pitch to height ratio of the blade is 2:1; the length of the shell is about 240 mm. The annular space defined by the radial gap is closed at either axial end of the pump body by means of two annular flanges. Inlet and outlet pipes provide communication with the auger channel in the pump body, and allow the liquid metal to be pumped in the cooling system. Suitable auxiliary cooling means may be provided for maintaining the desired working temperature of the pump. For example, the pump may be placed in a bath of cooling oil in order to prevent its temperature from increasing above the operating limit. The electric power to such a pump may be supplied via a three phases variac. The passage of electrical current through the stators urges the liquid metal to rotate within the annular space of the pump body, and thus to displace axially by means of the auger arrangement, thereby providing the pumping action for the cooling system. By changing the outlet voltage of the variac the flow rate of the liquid-metal through the pump may be controlled. The pump's temperature can also be monitored to prevent overheating.

Many other forms and configurations for the liquid metal pump are also possible.

The circuit 141 thus comprises a window 145 which interfaces with the frame 138 of the target 135 by means of flange 155. Flange 155, which is connected to the accelerator arrangement 110, is shaped to accommodate therein the target 135, which is clamped in place by means of clamp 149. The delivery end of fluid delivery line 142 is enclosed in a plenum chamber 148, and the return line 143 has an inlet on the walls of this chamber 148. The delivery end of the fluid delivery line 142 comprises a nozzle arrangement 170 adapted for directing a jet of cooled cooling fluid to the reverse side 137 of the target 135. The nozzle orifice 171 has a diameter D which is much smaller than the diameter of the target 135, and is axially spaced from the reverse side 137 at a distance z. The ratio z/D is preferably set as 0.8, though this ratio may be set at different values, such as for example 0.5 through to 5 or 6 or higher. The nozzle arrangement 170 comprises a converging section 172 upstream of the throat or orifice 171, and a diverging downstream section 173. The central axis 175 of the nozzle orifice 171 is aligned with the axis 150 of the particle beam 120.

The cooling system 140 is configured as a submerged jet system, that is, the plenum 148 is filled with cooling fluid, at least during operation of the cooling system. Thus the jet of cooling fluid from the nozzle 170 is injected through a static region of cooling fluid before striking the target, at least at the beginning of the fluid injection. In other embodiments, the jet provided by the nozzle arrangement 170 may impinge freely onto the target, and the plenum 148 is not fully filed with cooling fluid.

Preferably, a heat sensor is provided (not shown)for monitoring the temperature of the foil. Such a sensor may comprise, for example, thermocouples or pyrometers.

Optionally, the fluid flow parameters are controlled so that the Reynolds numbers for the fluid flow over all parts of the foil is substantially uniform and constant.

Typically, for water cooled cooling systems the following parameters exemplify cooling flow conditions at the target: jet velocities 10-100 m/s; Reynolds number 10⁵-2*10⁶; pressure loss due to jet 1-100 bar.

Typically, for cooling systems using liquid metals the following parameters exemplify cooling flow conditions at the target: Jet velocities 1-20 m/s; Reynolds number 10⁴-10⁶; Pressure loss due to jet 1-20 bar.

The cooling fluid is preferably a so called liquid metal or alloy, which has a melting point typically at least lower than the working temperature of the foil. Such liquid metals or alloys include, but are not restricted to, Gallium, Gallium-Indium, Tin-Indium-Gallium, or indeed Mercury, Sodium-Potassium. In one particular example, an eutectic alloy of Gallium and Indium may be used, having a melting point of 15.7° C., and typically, eutectic mixtures are used, though alternatively any ratio of metals may be used, typically according to the desired liquefaction temperature. Table IV below presents reference properties of several liquid metal/alloy coolants at room temperature.

TABLE IV
Physical Reference Parameters of Several Coolants

| | | | | Coolant | | |
|---|---|---|---|---|---|---|
| Parameter | | Water | Gallium | GaIn | NaK | Hg |
| Composition | | | | 67% Ga, 23% In | 78% K, 22% Na | |
| Melting temperature | C. | 0.0 | 29.8 | 15.7 | −11.1 | −38.8 |
| Boiling Temperature | C. | 100.0 | 2205 | 2000 | 783.8 | 356.8 |
| Density | kg/m³ | 1000 | 6100 | 6280 | 872 | 13599 |
| Heat capacity | J/kgK | 4181 | 373 | 326 | 1154 | 140 |
| Thermal conductivity | W/mK | 0.61 | 28 | 41.8 | 25.3 | 7.8 |
| Viscosity | 10⁻³ kg/ms | 0.855 | 1.96 | 1.69 | 0.468 | 1.55 |
| Kinematic viscosity | 10⁻⁸ m²/s | 85.5 | 32 | 27 | 53.7 | 11.4 |
| Prandtl number | — | 5.86 | 0.0261 | 0.0204 | 0.0213 | 0.0278 |

In a number of experiments conducted by some of the inventors of the present application to evaluate the potential of jet impingement for high heat flux cooling, a cooling circuit set up similar to that of FIG. 5 was used.

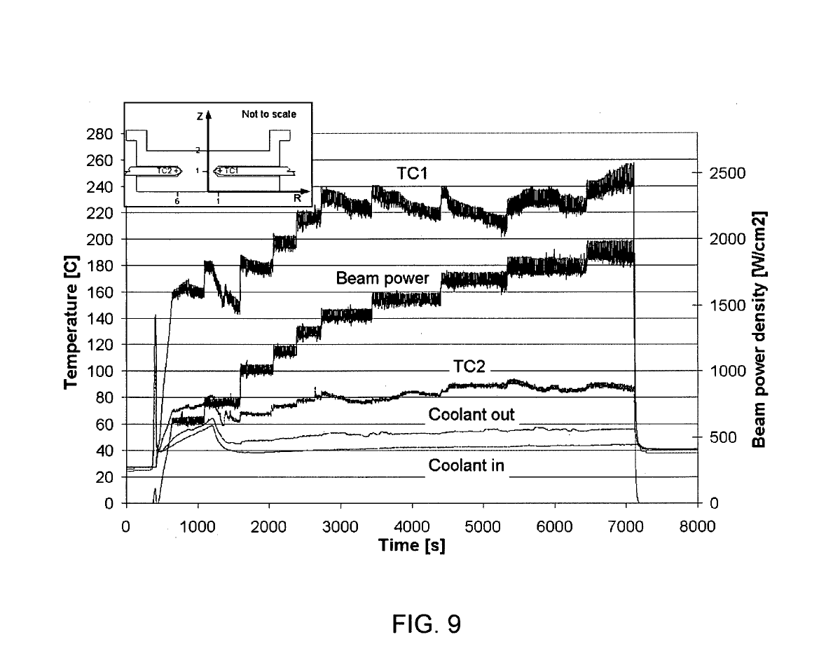

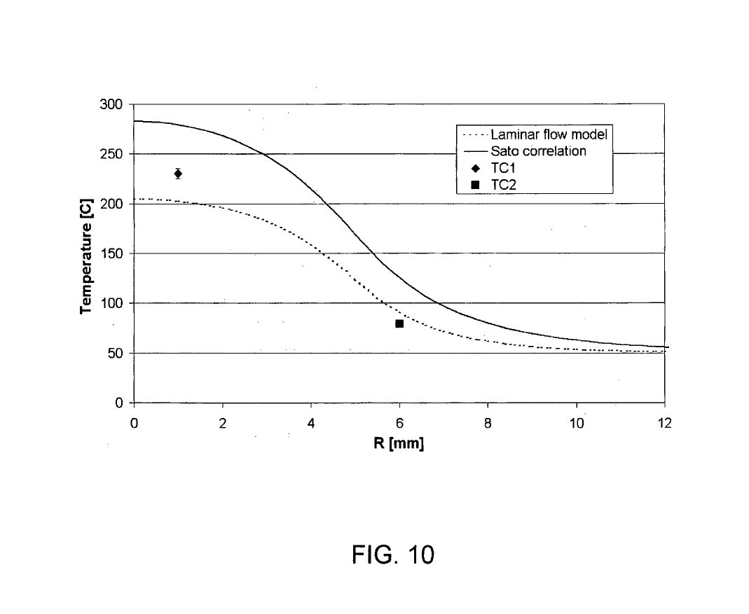

In these experiments, two thermocouples were installed in the target, one thermocouple TC1 was inserted 15 mm into the target to measure the temperature 1 mm from the center thereof, and the second thermocouple TC2 was inserted 10 mm into the target for measuring the temperature 6 mm from the center. In one experiment, the electron gun was set to heat a circular area of the target with a diameter of 10 mm. The gun power was increased in increments up to 2000 W/cm². FIG. 9 shows the beam power density and the resulting target and coolant temperatures. The target temperature responded immediately to any change in the beam power, and the target's heating rate was thousands of degrees per second due to its very low thermal mass relative to beam power density (e.g., 2000 K/sec for beam power density of 1 kW/cm²). The Gain flow rate was calculated from the total beam power and the temperature increase of the coolant as it passes through the cooling head. The jet velocity during the experiment was between about 2 and about 4 m/s, and the Reynolds number based on nozzle diameter was 40000-80000, which implies a turbulent flow. FIG. 10 presents results of a two-dimensional axi-symmetric calculation of the target disk temperature. The figure presents the temperature at mid distance between the upper and lower surfaces of the target, which is where the thermocouples TC1 and TC2 were located. The boundary conditions for the mathematical simulations also illustrated in the figure are the known heat flux on the heated surface, the measured coolant temperature, stagnation point heat transfer coefficient, and a distribution function for the heat transfer as function of the radial position that is take from Liu et. al. (Liu, X., Lienhard J. H. and Lombara J. S., Journal of Heat Transfer, 113 (1991) 571-582). The experimental results are compared with two theoretical calculations, one based on the Sato correlation (Sato, K., Furutani, A., Saito, M., Isozaki, M., Suganuma, K. and Imahori, S., Nuclear Engineering and Design, 132 (1991) 171-186), while the other was calculated from the laminar flow model (LF). The calculations are based on a heating power density of 1.4 kW/cm² and jet velocity of 2.35 m/s.

The results of the experiments indicate that that a GaIn system can deal with heat fluxes of about 2 kW/cm² over an area of about 1 cm² with a low jet velocity of less than 4 m/s. These results may be extrapolated to larger target sizes and power densities of the present invention.

It is estimated by the inventors that a cooling system using a Ga—In coolant can operate at about 1 bar for beam power densities of 6 kW/cm² or higher.

Alternatively, the cooling fluid may be water, though such a system needs to operate at much higher pressures and impingement velocities. It is estimated that a cooling system using water as coolant can operate at about 30 bar for beam power densities of 6 kW/cm² or higher.

Alternatively, the cooling fluid may be a gas, such as for example Helium.

Examples of appropriate design values for said cooling fluid are provided in Tables V and VI below.

TABLE V
Exemplary Nominal, Minimal and Maximal Design
Values for Liquid Metal Cooling System

| | | Minimum | Nominal | Maximum |
|---|---|---|---|---|
| Parameter | | value | value | value |
| Power | [kW] | 0 | 15 | 20 |
| Heat flux | [kW/cm²] | 0 | 1 | 5 |
| Flow rate | [l/s] | 0 | 0.5 | 0.5 |
| Jet velocity | [m/s] | 0 | 10 | 10 |
| Jet diameter | [mm] | 5 | 5 | 12 |
| Jet distance | [mm] | 4 | 4 | 20 |
| Coolant | [C.] | 40 | 50 | 75 |
| temperature | | | | |
| Wall temperature | [C.] | 40 | 200 | 200 |
| Coolant pressure | [bar] | 1 | 1 | 1.5 |
| Inlet pressure | [bar] | 1 | 9 | 9.5 |

TABLE VI
Exemplary Nominal, Minimal and Maximal
Values for Water Cooling System

| | | Minimum | Nominal | Maximum |
|---|---|---|---|---|
| Parameter | | value | value | value |
| Power | [kW] | 0 | 15 | 20 |
| Heat flux | [kW/cm²] | 0 | 1 | 5 |
| Flow rate | [l/s] | 0 | 2.5 | 3 |
| Jet velocity | [m/s] | 0 | 50 | 60 |
| Jet diameter | [mm] | 5 | 8 | 12 |
| Jet distance | [mm] | 4 | 4 | 20 |
| Coolant | [C.] | 20 | 30 | 50 |
| temperature | | | | |
| Wall temperature | [C.] | 20 | 200 | 200 |
| Coolant pressure | [bar] | 1 | 5 | 5 |
| Inlet pressure | [bar] | 1 | 25 | 32 |

It can be inferred from Table III above, then, that in order to use an oval shaped foil, of the aforementioned dimensions 110 mm×22 mm, an In—Ga cooling system may be suitable for 100μ thick foil, while for water cooling system, thicker foils, such as 250μ are required.

In any case, the cooling system pressure has to be compatible with the requirement not to breach the foil, and thus must take note of the results of Table III, which as mentioned earlier are rather conservative.

The configuration provided in FIG. 5 provides substantially uniform cooling in the circumferential direction at each radial station from the center of the target.

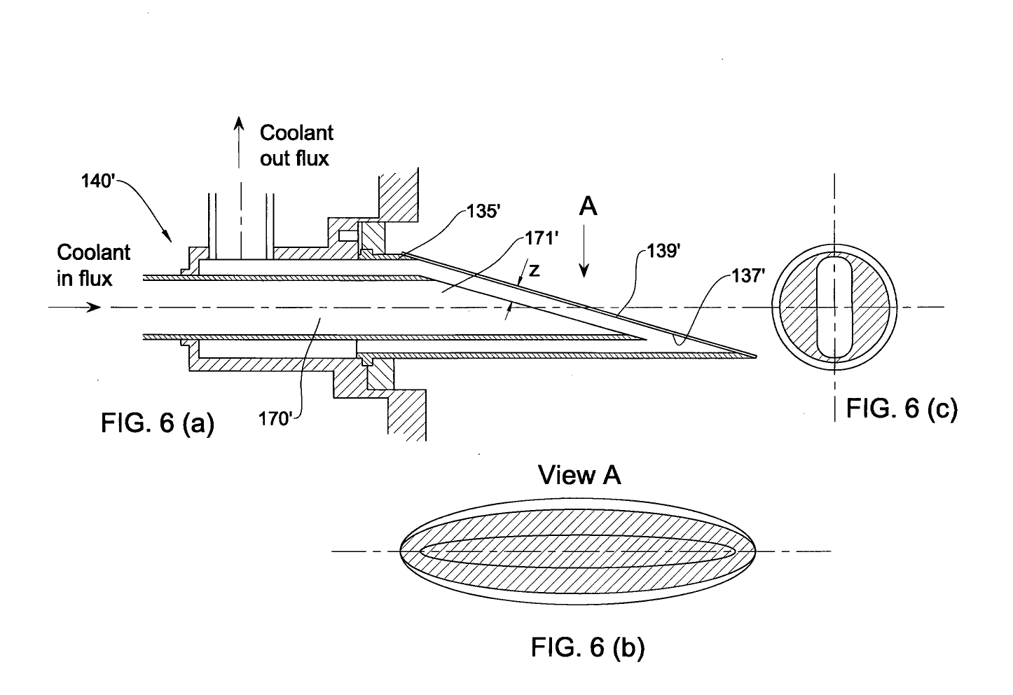

FIGS. 6(a) to 6(c) illustrate the cooling system 140′ when adapted for use with a beveled target, such as target 135′ illustrated in FIGS. 4(a) to 4(c). The cooling system 140′ is substantially similar to the system 140 described in connection with FIG. 5, mutatis mutandis, with the following differences. In system 140′, the cooling nozzle arrangement 170′ comprises a chamfered nozzle orifice 171′, such that the edge of the orifice 171′ is in a plane substantially parallel and spaced from the plane of the foil 139′. The orifice 171′ is profiled to comprise a similar cross-section when viewed along the axis 150 as the foil 139′ (compare FIG. 6(c) with FIG. 4(c)). In this case, the “nozzle diameter D” is replaced with an equivalent or effective diameter D′ (for example defined as exit area/circumferential area of exit; or major axis; or minor axis; or average between major and minor axes; and so on), and the spacing z is replaced with spacing z′ between the planes of the orifice 171′ and the reverse side 137′ of the foil 139′, taken orthogonally to the plane of the foil.

In another embodiment, a heat-sink materials, such as indium, or graphite, is placed as an intermediate layer between the foil and a backing layer, which provides further mechanical stability. During operation of the irradiation system, as the foil heats up, the intermediate layer can melt, improving the thermal conductivity between this and the backing layer, which is in turn cooled by the cooling system.

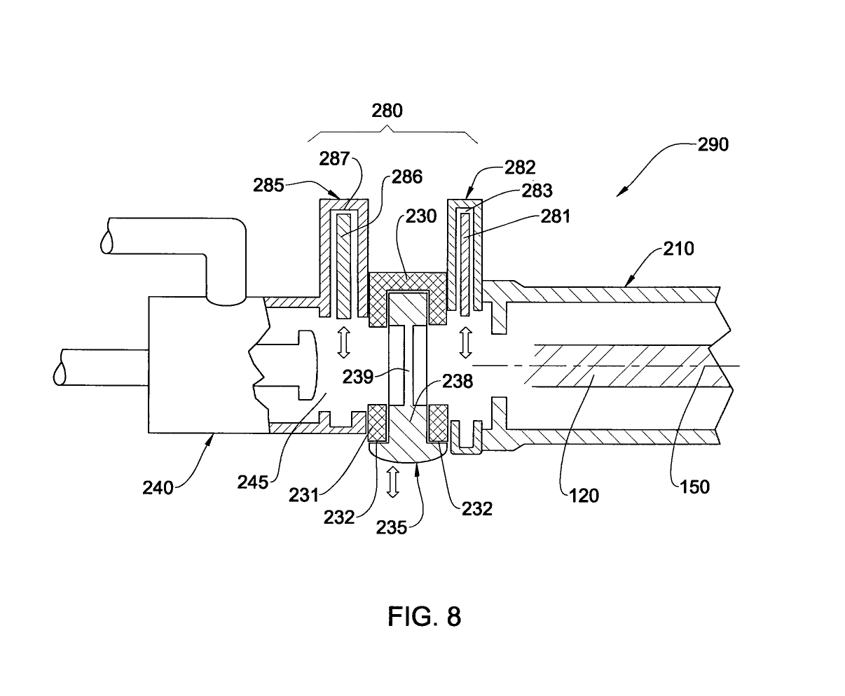

A second embodiment of the irradiation subsystem, illustrated in FIG. 8 and designated 290, is substantially similar to the first embodiment as described above, mutatis mutandis, with some differences as will become apparent. In the second embodiment, the irradiation subsystem 290 is adapted for enabling the targets to be replaced relatively quickly after being irradiated relative to the first embodiment, enabling the throughput and production yield rates of the desired isotopes to be increased. Accordingly, the target 235 is in the form of a cartridge having a target foil 239 mounted on a frame 238 which is adapted for being received and ejected from target station 230 by a simple sliding action, for example. Thus, the target station 230 and frame 238 may comprise complementary sliding rails (not shown), for example. The target station 230 may be integral with or mounted in a permanent or semi permanent manner to the accelerator 210 and/or the cooling system 240, and comprises a lateral opening 231 through which the target 235 may be inserted into the station 230. Further, suitable seals 232 may be provided around the periphery of the opening 231 to prevent leakage therethrough.

Optionally and preferably, the subsystem 290 further comprises an airlock system 280 for hermetically and selectively isolating the accelerator 210 and/or the cooling system 240 from the target station 230, particularly when the cartridge target 235 is removed and the target station is thus exposed to the ambient environment. The airlock system 280 comprises a door arrangement 282 comprising a sliding door 281 that slides from a retracted position within door housing 283, in which the beam 120 is unimpeded to reach the target station 230, to a closed position in which the door 281 seals the downstream end of the accelerator 210, maintaining the vacuum and preventing ingress of foreign matter or other contamination when the target is removed from the target station 230. The door 281 may be selectively actuated between the open and closed position by means of suitable actuators (not shown), which may be based on mechanical, hydraulic, pneumatic, electrical, electromagnetic or any other form of actuation, and controlled by means of a suitable control unit (not shown). Safety features may be incorporated preventing generation of the particle beam when the door 281 is in the closed position.

The airlock system 280 also comprises a second door arrangement 285 comprising a sliding door 286 that slides from a retracted position within door housing 287, in fluid communication with the target station 230 is blocked, to a closed position in which the door 286 seals the window 245 of the cooling system 240, preventing egress of cooling fluid therefrom or ingress of foreign matter or other contamination thereto when the target is removed from the target station 230. The door 286 may be selectively actuated between the open and closed position by means of suitable actuators (not shown), which may be based on mechanical, hydraulic, pneumatic, electrical, electromagnetic or any other form of actuation, and controlled by means of a suitable control unit (not shown).

With respect to the first embodiment of the irradiation subsystem, the second embodiment thereof does not require the target to be dismantled from the linear accelerator or the cooling system before further processing in the purification subsystem 160. Further, the potential problems of maintaining a vacuum in the accelerator or preventing leaking of cooling fluid from the cooling system, or indeed of contamination of the same are substantially avoided.

Further, the cartridges can be repacked in suitable containers in an automated fashion, and shipped to another location or stored, if desired, for subsequent processing by the purification subsystem.

Referring to FIG. 1, the purification subsystem 160 is adapted for purifying the said radioisotope from residual materials remaining after said interaction between the particle beam and the target material. Chemical or isotopic processing is carried out in the hot cell, and the purified isotope is the suitably packaged for storage or for transportation to a user.

The subsystem 160 comprises transfer means 161 to transfer the irradiated target to hot cells 163 which are adapted for the separation of the radioisotopes from residual matter in the target to provide carrier-free radioisotopes 165. The transfer means 161, in the present embodiment, comprises an aluminium tubing connecting the target station 130 with the hot cell 163, and pneumatic means provide air pressure to move the encapsulated target to the hot cell. Alternatively, the irradiated target is transferred manually to the hot cells, in which case, a lead shield encapsulates the target and thus prevent radiation contamination of the environment during transfer. The lead shield is removed in the hot cells. Typically, the hot cell is a lead chamber of dimensions such as for example 1.5 m×1.5 m×1.5 m.

Below are presented proposed examples relating to the productions of ¹⁷⁷Lu isotopes from Yb foils, and ¹⁰³Pd from Rh foils. Referring to Table I above, these isotopes are currently not producable by particle beam irradiation generated in linear accelerators or the like.

### EXAMPLE 1

### Production of Carrier-Free Lutetium 177 (¹⁷⁷Lu)

a. Irradiation Step

A natural ytterbium (¹⁷⁶Yb) foil (provided from Goodfellow Inc, UK, 99.99% pure), dimensions of the foil are: 100×13 mm, and 100-250 micron thick, and is irradiated by a deuteron beam at a continuous wave (cw) current of up to 2 mA according to the invention. The irradiation energy is 15-20 MeV (power=30 to 40 kW, power density 2.3 to 3.0 kW/cm²)

The irradiation time is 10 hours. The foil is cooled at its back side by eutectic mixture of Indium-Gallium (about 24.5/75.5 ratio respectively). Following the irradiation the target-foil is disconnected from the cooling system and transferred to a chemistry processing hot cell.

b. Purification Process

Target Dissolution

The irradiated ytterbium target is transferred to a hot cell according to the invention and immersed 1N HCl for 1 hour until complete dissolution of the foil occurs.

Chemical Separation of Lutetium From Ytterbium

There are two alternative methods for efficient separation between Lu and Yb, as follows:

I. Liquid-Liquid Extraction Method

The solution from the previous step containing Lu/Yb is mixed with equal volume of cyclohexane, and then 1% of the cationic ligand, di-(2-ethylhexyl) phosphoric acid (HDEHP). The mixture is vortexed for 30 minutes. Two phases are formed. Under these conditions there is preferential complexing of the lutetium over the ytterbium. Thus, the ytterbium is in the lower aqueous phase. The two phases are separated in a separation funnel. The liquid-liquid extraction is repeated 9-10 times. The aqueous phase is discarded, while the upper organic phase, containing the Lu—HDEHP complex is collected and kept for further purification of the Lu. The cyclohexane phase is then completely evaporated. The organic part of the complex is mineralized by treating the residue with a mixture of Aqua Regia/10% hydrogen peroxide (ratio 67/33 respectively). This step is repeated several times. Then the mixture is evaporated, and 4 ml of 6N HCL is added in order to reconstitute the Lu. The separation efficiency between lutetium and ytterbium is about 100%.

The yield of the produced Lu is expected to be approximately 75%.

II. Column Chromatography Separation

The solution from the previous step containing Yb/Lu mixture is loaded on a cation exchange column Aminex A6 (2×90mm) in the hot cell. The column is pre-conditioned with ammonium ions, and the elution is performed by using 0.07M α-hydroxybutyric acid (HIB), at pH-4.2. The fractions containing the Lu are collected first, and then the peak of Yb fractions. The separation procedure takes approx. 4 hours, and the separation yield is 80%.

Although not exemplified, the aforementioned procedures can be applied to other target configurations: different thickness of Yb foil, enriched Yb176 plated over a metal backing layer, such as copper, or an Yb foil juxtaposed to the backing layer. Usually, in order to achieve high and efficient heat dissipation, a maximum contact has to be maintained between the foil and the backing layer. This condition is frequently met, by employing heat-sink materials, such as indium, or graphite, as an intermediate layer between the foil and the backing layers. Other liquid metals can be used as liquid materials, such as sodium-potassium, and tin-gallium, as well as water.

### EXAMPLE 2

### Production of Palladium 103 (Pd-103)

a. Irradiation Step

A natural rhodium (¹⁰³Rh) foil (provided from Johnson Matthey Noble Metals Inc., 99.99% pure) is used as a target for irradiation. The foil is oval with dimensions of 100×12 mm, and 150-250 μm thick. The foil is irradiated by a deuteron beam in a continuous wave (cw) current of up to 2 mA according to the present invention. The irradiation energy is 17 MeV and irradiation time is 12-36 hours (power=34 kW, power density 2.8 kW/cm²)

The foil is cooled on its back side by eutectic mixture of indium-gallium (about 24.5/75.5 ratio respectively)

Following the irradiation the target is disconnected from the cooling system, and transferred for chemical processing in a hot cell.

b. Purification Process

The purification step (chemical) includes two major steps: (I) target dissolution, and (II) chemical separation between palladium and rhodium,

Target Dissolution

The target is dissolved within the hot cell by the following electrochemical procedure:

The Rh foil is immersed in the electrochemical cell, in 40 ml of 12N HCl. The cell is equipped with two graphite electrodes and a cooling system. An external current of 25 amperes is applied by an AC-source. The temperature during the procedure is kept below 90° C. After 2.5 hours more than 99% of the foil is dissolved.

Separation of Palladium From Rhodium

A liquid-liquid extraction method is used for the separation between palladium and rhodium.

The solution containing Pd and Rh from the previous step is evaporated to dryness. 3 ml of distilled water is added to the vial, and the solution pH is adjusted to 1.4, followed by the addition of 0.4 ml of α-furyloxime (AFD) monohydrate, 97% pure (stock solution 5% in ethanol, purchased from Lancaster Synthesis Inc. UK).

Under the above conditions AFD selectively forms a complex with Pd but not with Rh.

The solution is gently mixed, and then 25 ml of dichloromethane is added, and the mixture is stirred for 15 minutes. Two phases are formed; the upper aqueous pink solution contains Rh, while the lower organic phase contains the Pd-AFD complex. The two phases are separated by a separation funnel, and the lower phase is collected.

The organic phase is evaporated in a hot water bath until dryness, followed by addition of approx. 8 ml of a mixture of Aqua Regia and 10% hydrogen peroxide (ratio 67/37 respectively) is added to the vial in order to mineralize the organic residue of the complex. This step is continued until a complete dissolution occurs. After evaporation of the solution, 4 ml of 6N HCl was added, and finally the solution was filtered through a 0.45 μm filter.

The concentration of the produced palladium is determined by spectroscopic measuring the absorbance of the Pd solution at a wavelength of 474 nm, and compared to a reference calibration curve. The calibration curve of Pd and Rh are made by preparing stock solutions of 2 mg/ml palladium chloride in 6N HCl, and 2 mg/ml rhodium chloride trihydrate in 6N HCl, followed by diluting the stock solutions to concentrations of 30 μg/ml to 1 mg/ml. The maximum of the absorbance spectrum for Pd is 474 nm, and for Rh the maximum is at 525 nm. At this range the calibration curves are linear.

The yield of the isolated palladium is expected to be 97-99%.

Although not exemplified, the aforementioned procedures can be applied to other target configurations: different thickness of Rh foil, Rhodium plated over a metal backing layer, such as copper, or an Rh foil juxtaposed to the backing layer. Usually, in order to achieve high and efficient heat dissipation, a maximum contact has to be maintained between the foil and the backing layer. This condition is frequently met, by employing heat-sink materials, such as indium, or graphite, as an intermediate layer between the foil and the backing layers. Other liquid metals can be used as liquid materials, such as sodium-potassium, and tin-gallium, as well as water.

TABLE VII
Comparison of Particle Beam Conditions for Transmutation
of Target Material for the Creation of Isotopes (a) State
of the Art; (b) According to the Present Invention

| | A | | | | B | | | |
|---|---|---|---|---|---|---|---|---|
| | State of the Art | | | | The Present Invention | | | |
| | | | | kW/ | | | | kW/ |
| Isotope | MeV | mA | kW | cm2 | MeV | mA | kW | cm2 |
| Lu177 | Reactor - | — | — | — | 15 | 2 | 30 | 3 |
| (d) | produced | | | | | | | |
| Pd-103 | 14 | 0.4 | 5.6 | 0.56 | 14 | 2 | 28 | 2.8 |
| (p) | | | | | | | | |
| Pd-103 | Not | — | — | — | 17 | 2 | 34 | 3.4 |
| (d) | available | | | | | | | |
| Re-186 | 28 | 0.2 | 5.6 | 0.56 | 28 | 2 | 56 | 5.6 |
| Cu-64 | 30 | 0.2 | 6 | 0.6 | 30 | 2 | 60 | 6 |
| In-111 | 18 | 0.18 | 3.2 | 0.32 | 18 | 2 | 36 | 3.6 |
| Ga-67 | 28 | 0.15 | 4.2 | 0.42 | 28 | 2 | 56 | 5.6 |
| Tl-201 | 30 | 0.2 | 6 | 0.6 | 30 | 2 | 60 | 6 |
| At-211 | 28 | 0.1 | 2.8 | 0.28 | 28 | 2 | 56 | 5.6 |
| Ac-225 | 28 | 0.1 | 2.8 | 0.28 | 28 | 2 | 56 | 5.6 |

Notes:
1. Target area assumed ˜10 cm².
2. (p)—protons
3. (d)—deuterons
4. For ¹⁷⁷Lu and ¹⁰³Pd(d) in the prior art it is not possible to produce these isotopes by cyclotrons, by deuterons irradiation.
5. For the isotopes: ¹⁷⁷Lu, ¹⁰³Pd (d), ²⁰¹Tl, ²²⁵Ac, ¹¹¹In, and ²¹¹At; the production yield using the irradiation system of present invention is significantly enhanced.

Target materials for the target to be radiated may include any one of the following materials: copper, molybdenum, gold, silver, niobium, tungsten, rhodium, tungsten, ytterbium, radium, zinc, bismuth, tantalum, silver, rhodium, cadmium, zinc, nickel, radium, thallium, iodine, silver, rhodium, thallium, tungsten, tantalum, zinc, nickel, cadmium, bismuth, radium and ytterbium.

The present invention may be utilized for the transmutation of materials to produce at least the following radioisotopes of interest, and typical beam conditions are given in Table VII for their generation (and compared with prior art):
i. Lutetium 177 (¹⁷⁷Lu) obtained from target material ytterbium 176 (¹⁷⁶Yb) (For example, as described in Example 1 above).
ii. Palladium 103 (¹⁰³Pd) obtained from target material natural rhodium (¹⁰³Rh). (For example, as described in Example 2 above).
iii. Lutetium 177 (¹⁷⁷Lu) obtained from target material Tantalum 181 (¹⁸¹Ta).
iv. Palladium 103 (¹⁰³Pd) obtained from target material natural silver.
v. Rhenium 186 (¹⁸⁶Re) obtained from target material tungsten 186 (¹⁸⁶W).
vi. Copper 64 (⁶⁴Cu) obtained from target material natural zinc.
vii. Copper 64 (⁶⁴Cu) obtained from target material nickel 64 (⁶⁴Ni).
viii. Indium 111 (¹¹¹In) obtained from target material cadmium 112 (¹¹²Cd)
ix. Gallium 67 (⁶⁷Ga) obtained from target material zinc 66 (⁶⁶Zn).
x. Gallium 67 (⁶⁷Ga) obtained from target material zinc 67 (⁶⁷Zn).
xi. Thallium 201 (²⁰¹Tl) obtained from target material thallium 203 (²⁰³Tl).
xii. Astatine 211 (²¹¹At) obtained from target material natural bismuth.
xiii. Iodine-125 (¹²⁵) obtained from target material natural iodine.
xiv. Actinium 225 (²²⁵Ac) obtained from target material radium 226 (²²⁶Ra).

The desired isotopes Lutetium 177 and Palladium 103 in (a) and (b) above, respectively, may be obtained as described in Examples 1 and 2 above, respectively, for example. The desired isotopes in (iii) to (xvi) above may also be obtained in a similar manner to those described in Examples 1 and 2, mutatis mutandis, from their respective target materials.

In the method claims that follow, alphanumeric characters and Roman numerals used to designate claim steps are provided for convenience only and do not imply any particular order of performing the steps.

Finally, it should be noted that the word “comprising” as used throughout the appended claims is to be interpreted to mean “including but not limited to”.

While there has been shown and disclosed exemplary embodiments in accordance with the invention, it will be appreciated that many changes may be made therein without departing from the spirit of the invention.

1. A system for production of at least one radioisotope by the transmutation of target isotopes, comprising:
a source for generating a continuous wave ion beam;
a target for said beam comprising said target isotope and positioned such that said beam interacts with said target isotope;
cooling means for cooling the target, and configured for enabling transference of heat away from said target at heat fluxes of at least about 1 kW/cm².

2. A system according to claim 1, wherein said cooling system comprises a cooling fluid.

3. A system according to claim 2, wherein said cooling fluid comprises any one of a liquid metal or liquid metal alloy.

4. A system according to claim 3, wherein said cooling fluid comprises at least one of Gallium, Gallium-Indium, Tin-Indium-Gallium, Mercury, Sodium-Potassium.

5. A system according to claim 2, wherein said cooling fluid comprises water.

6. A system according to claim 2, wherein said cooling fluid comprises a gas.

7. A system according to claim 6, wherein said cooling fluid comprises helium.

8. A system according to claim 1, wherein said target is in the form of a foil of target material mounted to a frame.

9. A system according to claim 1, further comprising a purification subsystem for purifying the said radioisotope from residual materials remaining after said interaction.

10. A system according to claim 1, wherein said target material is any one of copper, molybdenum, gold, silver, niobium, tungsten, rhodium, ytterbium, radium, zinc, bismuth, tantalum, cadmium, nickel, thallium and iodine.

11. Method for the production of at least one radioisotope by the transmutation of target isotopes, comprising:
generating a continuous wave ion beam;
irradiating a target comprising said target isotope with said beam, wherein said target is positioned such that said generated beam interacts with said target isotope;
transferring heat away from said target at heat fluxes of at least about 1 kW/cm².

12. A method according to claim 11, wherein a flowable cooling fluid transfers said heat away from said target.

13. A method according to claim 12, wherein said cooling fluid comprises any one of a liquid metal or metal alloy.

14. A method according to claim 13, wherein said cooling fluid comprises at least one of Gallium, Gallium-Indium, Tin-Indium-Gallium, Mercury, Sodium-Potassium.

15. A method according to claim 12, wherein said cooling fluid comprises water.

16. A method according to claim 12, wherein said cooling fluid comprises a gas.

17. A method according to claim 12, wherein said cooling fluid comprises helium.

18. A system according to claim 11, wherein said target is in the form of a foil of target material mounted to a frame.

19. Method according to claim 11, further comprising the step of purifying the said radioisotope from residual materials remaining after said irradiation.

20. A method according to claim 11, wherein said target material is any one of copper, molybdenum, gold, silver, niobium, tungsten, rhodium, ytterbium, zinc, bismuth, tantalum, cadmium, nickel, radium, thallium and iodine.

21. Lutetium 177 (¹⁷⁷Lu) obtained by a method according to claim 11 from target material ytterbium 176 (¹⁷⁶Yb).

22. Palladium 103 (¹⁰³Pd) obtained by a method according to claim 11 from target material natural rhodium (¹⁰³Rh).

23. Lutetium 177 (¹⁷⁷Lu) obtained by a method according to claim 11 from target material Tantalum 181 (¹⁸¹Ta).

24. Palladium 103 (¹⁰³Pd) obtained by a method according to claim 11 from target material natural silver.

25. Rhenium 186 (¹⁸⁶Re) obtained by a method according to claim 11 from target material tungsten 186 (¹⁸⁶W).

26. Copper 64 (⁶⁴Cu) obtained by a method according to claim 11 from target material natural zinc.

27. Copper 64 (⁶⁴Cu) obtained by a method according to claim 11 from target material nickel 64 (⁶⁴Ni).

28. Indium 111 (¹¹¹In) obtained by a method according to claim 11 from target material cadmium 112 (¹¹²Cd).

29. Gallium 67 (⁶⁷Ga) obtained by a method according to claim 11 from target material zinc 66 (⁶⁶Zn).

30. Gallium 67 (⁶⁷Ga) obtained by a method according to claim 11 from target material zinc 67 (⁶⁷Zn).

31. Thallium 201 (²⁰¹Tl) obtained by a method according to claim 11 from target material thallium 203 (²⁰³Tl).

32. Astatine 211 (²¹¹At) obtained by a method according to claim 11 from target material natural bismuth.

33. Iodine-125 (125I) obtained by a method according to claim 11 from target material natural iodine.

34. Actinium 225 (²²⁵Ac) obtained by a method according to claim 11 from target material radium 226 (²²⁶Ra).
